(19) United States
(12) Patent Application Publication
(10) Pub. No.: US 2021/0227857 A1
(43) Pub. Date: Jul. 29, 2021

(54) LUO HAN GUO JUICE AND PREPARATION METHOD THEREOF

(71) Applicant: GUILIN LAYN NATURAL INGREDIENTS CORP., Guilin, Guangxi (CN)

(72) Inventors: Wenguo YANG, Guilin (CN); Yongfu XIE, Guilin (CN); Yunfei SONG, Guilin (CN); Yuanyuan LI, Guilin (CN); Zhizhou JIANG, Guilin (CN)

(73) Assignee: GUILIN LAYN NATURAL INGREDIENTS CORP., Guilin, Guangxi (CN)

(21) Appl. No.: 17/059,996

(22) PCT Filed: Mar. 7, 2018
(86) PCT No.: PCT/CN2018/078213

§ 371 Date: Nov. 30, 2020

(30) Foreign Application Priority Data
Dec. 8, 2017 (CN) 201711293896.7

(51) Int. Cl. A23L 2/84; A23L 2/02

(52) U.S. Cl. CPC A23L 2/84; A23L 2/02

(57) ABSTRACT

Luo han guo juice and a preparation method thereof. The method comprises: preparing fresh luo han guo fruits, and washing and grinding the same; adding a macerating enzyme; and performing enzymolysis under an ultra-high pressure of 120-220 MPa and maintaining the pressure for 10-15 minutes.

### TECHNICAL FIELD

The present invention relates to the field of food processing, specifically, to a LUO HAN GUO juice and a preparation method thereof.

### BACKGROUND ART

Most conventional preparation methods of LUO HAN GUO juice adopt extraction by soaking with heated water. In recent years, more efficient enzymolysis methods have been reported to prepare fresh LUO HAN GUO juice. For example, Chinese patent document CN101167539A discloses a method for producing a deodorized concentrated juice of LUO HAN GUO fresh fruits, comprising the steps of: (1) crushing and mashing LUO HAN GUO fruits; (2) adjusting pH to 3.5 to 7.5, performing enzymolysis with immobilized fruit pulp enzyme at 10° C. to 60° C. for 20 to 60 minutes to give LUO HAN GUO juice; (3) clarifying the juice with an ultrafiltration enzyme and an ultrafilter; (4) deodorizing with activated carbon; and (5) concentrating, performing pasteurization, ultraviolet or ultra-high temperature sterilization. In the reference document 1, the immobilized fruit pulp enzyme is used for low-temperature enzymolysis to obtain LUO HAN GUO juice, but the enzymolysis process is time-consuming, and after concentration, high-temperature operations such as pasteurization and ultra-high temperature sterilization are adopted, resulting in a high loss of heat sensitive nutrients and flavor components. Chinese patent document CN101283831A discloses a preparation method of a decolorized LUO HAN GUO juice and the juice prepared by the method, wherein the method comprises the steps of: (1) adding pectinase for the first time, holding and extracting at 37° C. for 2 h, performing primary filtration, then adding pectinase in the same weight as that of the first time to the filter residue, and holding and extracting at the same temperature for 1 h, filtering again and combining the first filtrate and second filtrate; (2) passing the obtained mixture through a cation column; (3) passing through a decolorizing resin; (4) performing first acidification; (5) concentrating; and (6) performing second acidification. In the reference document 2, pectinase is used for low-temperature enzymolysis to obtain LUO HAN GUO juice, but the enzymolysis process is time-consuming, and enzymolysis for too long time will lead to excessive degradation of nutrients and flavor components by other biological enzymes.

Fruit pulp enzyme or pectinase as a single enzyme has a narrow range of objects of enzymolysis, and the enzymolysis efficiency is not as high as that of a macerating enzyme composed of pectinase, cellulase, protease, amylase, xylanase and the like. The macerating enzyme is a complex enzyme obtained from Aspergillus niger by solid-state fermentation. It mainly contains pectinase, cellulose and xylanase, and further contains protease, amylase and the like. During the processing of fruits and vegetables, the macerating enzyme can disaggregate fruits and break plant cells to soften the raw materials of fruits and vegetables like porridge, thereby improving the yield and clarity and reducing the viscosity of juice of fruits and vegetables. At present, there is no report on the method of preparing LUO HAN GUO juice by enzymolysis with a macerating enzyme.

The efficiency and time of enzymolysis are mainly affected by the activity of the enzyme. The higher the activity of the enzyme, the shorter the time used for enzymolysis and the higher the efficiency. In addition, the activity of the enzyme is affected by temperature, pH, and pressure of the environment. The activity of the enzyme will be increased or decreased by adjusting the factors such as the temperature, pH, and pressure of the environment, thereby affecting the enzymolysis time and enzymolysis efficiency.

Ultra-high pressure (MHP) treatment, also known as high hydrostatic pressure (HHP) treatment, refers to a new technology in which water or other liquid is used as the pressure transmission medium, to achieve the effects of sterilization, inactivating enzyme and improving food functional characteristics by pressure treatment at 100 MPa or more at room temperature or even lower temperature. Therefore, the conventional ultra-high pressure treatment will not only inhibit the activity of the enzyme, but also is unfavorable to the enzymolysis reaction. The document Influence of Ultra-high Pressure Treatment on Activity of Pectinase and Peroxidase in Fresh Orange Juice (Chen Heqing et al., Food Science 2011 (15): 54-57) discloses that after treating for 10 min at room temperature of 15° C. in an ultra-high pressure environment under a pressure of 200 MPa, the enzyme activity of pectinase is increased by 1% to 2% compared with that at normal pressure, and when the pressure is ≥300 MPa, the enzyme activity is reduced by about 30%. Therefore, with a certain treatment time, if an activity curve is plotted taking the pressure as the abscissa and the enzyme activity as the ordinate, the curve comprises a peak region in which the enzyme activity first increases and then decreases as the pressure continuously increases (hereinafter referred to as “activation region”). Therefore, the enzymes can be activated to a certain extent when treated under certain ultra-high pressure conditions. However, enzymes have high biological specificity, and the activation regions of different enzymes may overlap or may not overlap. Some enzymes even do not have said activation regions.

At present, there is no public report about activating the macerating enzyme by ultra-high pressure treatment, and there is no public report about preparation of LUO HAN GUO juice by ultra-high pressure treatment in combination with the macerating enzyme, either.

Temperature is one of the core factors affecting the activity of enzymes. In order to achieve the maximum enzymolysis efficiency, keeping the enzymolysis environment at the optimal temperature is the prerequisite for achieving the maximum enzymolysis efficiency. For the macerating enzyme, the optimum temperature for the highest enzyme activity is 45° C.; but for LUO HAN GUO, the temperature of 45° C. causes the loss of some nutrients and flavor components, which ultimately affects the taste of the finished product.

### SUMMARY OF THE INVENTION

In order to overcome the defects in the prior art, the present invention provides a preparation method of LUO HAN GUO juice. The method adopts ultra-high pressure in combination with a macerating enzyme to cooperatively treat LUO HAN GUO, so as to improve the efficiency of enzymolysis, shorten the time of enzymolysis, and increase the yield of fruit juice; and the method also adopts low-temperature ultra-high pressure sterilization, and the sterilization effect can not only meet the quality requirements of eating and preservation, but also retain the nutrients and flavor components in the juice.

The purpose of the present invention can be achieved through the following technical solutions:

The present invention provides a preparation method of LUO HAN GUO juice, wherein the method comprises the following steps: taking fresh LUO HAN GUO fruits, adding a macerating enzyme, and performing enzymolysis while maintaining an ultra-high pressure of 120 to 220 MPa for 10 to 15 min to obtain enzymolyzed LUO HAN GUO juice.

During the research, the applicant of the present invention has found that, after the macerating enzyme was treated for 10 to 15 min under an ultra-high pressure of 120 to 220 MPa at a temperature of <45° C. (the appropriate temperature recommended in the product specification of the macerating enzyme), the phenomenon that the components in the macerating enzyme are further activated simultaneously is observed, the residual enzyme activities of pectinase, cellulase, protease, amylase, and xylanase are up to (110.26±0.48)%, (125.72±0.39)%, (108.58±0.16)%, (110.52±0.46)%, and (118.69±0.24)%, respectively. Compared with the macerating enzyme treated at a temperature of 15° C. under normal pressure, the juice yield is increased by 22%, and the time required to reach the same juice output is reduced by 52%. Compared with the macerating enzyme treated at a temperature of 45° C. under normal pressure, the juice yield is increased by 23%, and the time required to reach the same juice output is reduced by 18%.

Preferably, fresh LUO HAN GUO fruits are taken, a macerating enzyme is added, and enzymolysis is performed under an ultra-high pressure of 140 to 180 MPa by maintaining the pressure for 12 to 14 min to obtain enzymolyzed LUO HAN GUO juice.

Preferably, the enzymolysis is performed under an ultra-high pressure at a temperature of ≤30° C. The specified temperature is adopted to avoid the destruction of nutrients and loss of flavor components caused by high temperature, so as to effectively maintain the original flavor and nutrients of LUO HAN GUO, and improve the mouthfeel and nutritional value of the obtained LUO HAN GUO juice.

Preferably, the usage amount of the macerating enzyme is 0.5‰ to 1‰ of the weight of the fresh fruits, and the composition ratio of the macerating enzyme is as follows: pectinase 3500 to 5000μ/g, cellulase 100 to 200μ/g, amylase 2000 to 3000μ/g, protease 4000 to 8000μ/g, and xylanase 3500 to 5000μ/g. With the macerating enzyme in the specified amount and ratio, the components of pectin, cellulose, starch, protein and the like in LUO HAN GUO can be effectively degraded in a short time, so as to promote the LUO HAN GUO juice to be quickly released from cells.

Preferably, the enzymolyzed LUO HAN GUO juice is taken, and the enzyme inactivation is performed under an ultra-high pressure of ≥400 MPa by maintaining the pressure for 5 to 10 min to obtain enzyme-inactivated LUO HAN GUO juice. During the research, the inventors of the present invention has found that if the pressure is further increased to 400 MPa or more, the activity of each component in the macerating enzyme gradually decreases with the increase of the pressure maintaining time. Therefore, the macerating enzyme can be inactivated by treatment under the specified ultra-high pressure conditions, so as to achieve the effect of stopping enzymolysis.

Preferably, the enzyme-inactivated LUO HAN GUO juice is taken, and processed by a filter press or a high-speed centrifuge to obtain clarified LUO HAN GUO juice.

Preferably, when a filter press is used for processing, the LUO HAN GUO juice obtained after enzyme inactivation is passed through a filter screen of 200 to 400 mesh with an operating pressure of ≥0.2 MPa. With the defined filter press, a part of large-particle impurities can be removed, and the clarity of LUO HAN GUO juice can be improved.

Preferably, when a high-speed centrifuge is used for processing, the rotation speed is 2000 to 4000 r/min, and the centrifugation time is 5 to 10 min. With the defined high-speed centrifuge, a part of large-particle impurities can be removed, and the clarity of LUO HAN GUO juice can be improved.

Preferably, the clarified LUO HAN GUO juice is taken, a yeast is added for treatment for 30 to 480 min, and then the yeast is separated to obtain LUO HAN GUO juice treated with yeast. By adding the yeast for treatment, the disaccharides and monosaccharides in the fruit juice are decomposed by the yeast, such that the effect of reducing the sugar content and calories is achieved. In addition, in the specified treatment time, the yeast has less effect on mogrosides, which highlights the unique flavor of mogrosides while reducing the content of other sugars in the juice, and improves the flavor and taste of LUO HAN GUO juice.

Preferably, the usage amount of the yeast is 1.5-2.0‰ of the weight of the fresh fruits, and the yeast is fresh yeast or dry yeast.

Preferably, the LUO HAN GUO juice treated with yeast is taken and treated with activated carbon, so as to obtain LUO HAN GUO juice treated with activated carbon.

Preferably, the usage amount of the activated carbon is 2.5‰ of the weight of the fresh fruits, the particle size of the activated carbon is 60 to 120 mesh, and the activated carbon is loaded on a chromatography column with a diameter of ≥5 cm to allow the LUO HAN GUO juice treated with yeast to pass through the chromatography column With the defined activated carbon and treatment method, undesirable tastes such as sourness and bitterness can be better removed, so as to improve the flavor and mouthfeel of the product. Meanwhile, residual heavy metals and pesticides in the raw materials can be removed to improve food safety of the product.

Preferably, the LUO HAN GUO juice treated with activated carbon is passed through an ultrafiltration membrane, and the filtrate portion is then concentrated by a nanofiltration membrane to obtain concentrated LUO HAN GUO juice. The pH of the concentrated LUO HAN GUO juice is adjusted to 4.0 to 6.5 to obtain LUO HAN GUO juice with weakly acidic pH.

Preferably, the molecular weight cut-off of the ultrafiltration membrane is 50000 to 60000 Daltons, the molecular weight cut-off of the nanofiltration membrane is 100 to 150 Daltons, and the Brix of the concentrated LUO HAN GUO juice is 5° to 65°. With the defined ultrafiltration membrane, impurities with a molecular weight of >50000 Daltons are further removed. With the defined nanofiltration membrane, excessive liquid is removed, so as to facilitate further preparation and processing.

Preferably, the LUO HAN GUO juice with weakly acidic pH is taken and sterilized at a temperature of ≤30° C. under an ultra-high pressure of 500 to 550 MPa by maintaining the pressure for 20 to 30 min to obtain sterilized LUO HAN GUO juice. During the research, the inventors of the present invention has found that, when the pressure is increased to 500 MPa or more in an environment at a temperature of ≤30° C., the total number of bacterial colonies of bacterial microorganisms will gradually decrease with the increase of the pressure maintaining time, and the same sterilization effect as high temperature sterilization can be achieved. Therefore, the treatment of the LUO HAN GUO juice having weakly acidic pH under the defined ultra-high pressure can kill various bacterial microbial colonies to a total number meeting food requirements, and low temperature operation helps to maintain the nutrients and flavor components of LUO HAN GUO juice.

The present invention also provides a LUO HAN GUO juice, wherein the LUO HAN GUO juice is prepared by any of the above methods.

Compared with the prior art, the method of the present invention has the following advantages:

1. By using a macerating enzyme to treat LUO HAN GUO, the present invention provides higher enzymolysis efficiency, shorter juicing time and higher juice yield compared with a single enzyme.

2. The present invention adopts ultra-high pressure treatment to improve the activity of each component in the macerating enzyme, thereby further shortening the juicing time and increasing the juice yield.

3. The present invention adopts ultra-high pressure instead of heating to accelerate enzymolysis, enzyme inactivation, and sterilization, and the entire process is operated at low temperature to avoid damage to nutrients and loss of flavor components that may be caused by high temperature.

4. The present invention has a short operating time, mainly adopts pressure regulation as the operating condition, has good process continuity and high production efficiency, and is suitable for industrialized production.

### SPECIFIC MODES FOR CARRYING OUT THE EMBODIMENTS

The following examples are intended to illustrate the present invention, but are not intended to limit the scope of the present invention.

### Example 1

(1) 200 kg of LUO HAN GUO fresh fruits were taken, washed and crushed, 0.1 kg of a macerating enzyme was added, and enzymolysis was performed under an ultra-high pressure of 220 MPa by maintaining the pressure for 10 min to obtain LUO HAN GUO juice (a); (2) the LUO HAN GUO juice (a) was taken, and enzyme inactivation was performed under an ultra-high pressure of 400 MPa by maintaining the pressure for 5 min to obtain LUO HAN GUO juice (b);

(3) the LUO HAN GUO juice (b) was treated with a filter press, and the LUO HAN GUO juice (b) was passed through a filter screen of 200 mesh with an operating pressure of 0.2 MPa to obtain LUO HAN GUO juice (c);

(4) the LUO HAN GUO juice (c) was taken, 0.3 kg of dry yeast was added for treatment for 30 min, and then the yeast was separated to obtain LUO HAN GUO juice (d);

(5) the LUO HAN GUO juice (d) was treated with activated carbon, wherein the usage amount of the activated carbon was 0.5 kg, the particle size of the activated carbon was 60 mesh, the activated carbon was loaded on a chromatography column with a diameter of 5 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 50,000 Daltons, and the filtrate portion was then concentrated to 5 Brix by a nanofiltration membrane with a molecular weight cut-off of 100 Daltons to obtain LUO HAN GUO juice (f);

(7) citric acid was added to adjust the pH of LUO HAN GUO juice (f) to 4.0 to obtain LUO HAN GUO juice (g); and

(8) the LUO HAN GUO juice (g) was taken, and sterilization was performed under an ultra-high pressure of 500 MPa by maintaining the pressure for 30 min to obtain LUO HAN GUO juice (h).

The above steps were all performed in an environment at a temperature of 15° C.

### Example 2

(1) 200 kg of LUO HAN GUO fresh fruits were taken, washed and crushed, 0.2 kg of a macerating enzyme was added, and enzymolysis was performed under an ultra-high pressure of 200 MPa by maintaining the pressure for 11 min to obtain LUO HAN GUO juice (a);

(2) the LUO HAN GUO juice (a) was taken, and enzyme inactivation was performed under an ultra-high pressure of 400 MPa by maintaining the pressure for 6 min to obtain LUO HAN GUO juice (b);

(3) the LUO HAN GUO juice (b) was treated with a filter press, and the LUO HAN GUO juice (b) was passed through a filter screen of 300 mesh with an operating pressure of 0.6 MPa to obtain LUO HAN GUO juice (c);

(4) the LUO HAN GUO juice (c) was taken, 0.3 kg of a fresh yeast was added for treatment for 120 min, and then the yeast was separated to obtain LUO HAN GUO juice (d);

(5) the LUO HAN GUO juice (d) was treated with activated carbon, wherein the usage amount of the activated carbon was 0.5 kg, the particle size of the activated carbon was 90 mesh, the activated carbon was loaded on a chromatography column with a diameter of 6 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 50,000 Daltons, and the filtrate portion was then concentrated to 20 Brix by a nanofiltration membrane with a molecular weight cut-off of 150 Daltons to obtain LUO HAN GUO juice (f);

(7) citric acid was added to adjust the pH of LUO HAN GUO juice (f) to 4.5 to obtain LUO HAN GUO juice (g); and

(8) the LUO HAN GUO juice (g) was taken, and sterilization was performed under an ultra-high pressure of 500 MPa by maintaining the pressure for 30 min to obtain LUO HAN GUO juice (h).

The above steps were all performed in an environment at a temperature of 20° C.

### Example 3

(1) 400 kg of LUO HAN GUO fresh fruits were taken, washed and crushed, 0.2 kg of a macerating enzyme was added, and enzymolysis was performed under an ultra-high pressure of 180 MPa by maintaining the pressure for 12 min to obtain LUO HAN GUO juice (a);

(2) the LUO HAN GUO juice (a) was taken, and enzyme inactivation was performed under an ultra-high pressure of 400 MPa by maintaining the pressure for 7 min to obtain LUO HAN GUO juice (b);

(3) the LUO HAN GUO juice (b) was treated with a filter press, and the LUO HAN GUO juice (b) was passed through a filter screen of 400 mesh with an operating pressure of 1 MPa to obtain LUO HAN GUO juice (c);

(4) the LUO HAN GUO juice (c) was taken, 0.6 kg of a dry yeast was added for treatment for 90 min, and then the yeast was separated to obtain LUO HAN GUO juice (d);

(5) the LUO HAN GUO juice (d) was treated with activated carbon, wherein the usage amount of the activated carbon was 1.0 kg, the particle size of the activated carbon was 120 mesh, the activated carbon was loaded on a chromatography column with a diameter of 7 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 60,000 Daltons, and the filtrate portion was then concentrated to 40 Brix by a nanofiltration membrane with a molecular weight cut-off of 150 Daltons to obtain LUO HAN GUO juice (f);

(7) citric acid was added to adjust the pH of LUO HAN GUO juice (f) to 6.5 to obtain LUO HAN GUO juice (g); and

(8) the LUO HAN GUO juice (g) was taken, and sterilization was performed under an ultra-high pressure of 530 MPa by maintaining the pressure for 25 min to obtain LUO HAN GUO juice (h).

The above steps were all performed in an environment at a temperature of 30° C.

### Example 4

(1) 400 kg of LUO HAN GUO fresh fruits were taken, washed and crushed, 0.4 kg of a macerating enzyme was added, and enzymolysis was performed under an ultra-high pressure of 160 MPa by maintaining the pressure for 13 min to obtain LUO HAN GUO juice (a);

(2) the LUO HAN GUO juice (a) was taken, and enzyme inactivation was performed under an ultra-high pressure of 400 MPa by maintaining the pressure for 8 min to obtain LUO HAN GUO juice (b);

(3) the LUO HAN GUO juice (b) was treated by a high-speed centrifuge with a rotation speed of 2000 r/min and centrifugation time of 10 min to obtain LUO HAN GUO juice (c);

(4) the LUO HAN GUO juice (c) was taken, 0.8 kg of a fresh yeast was added for treatment for 240 min, and then the yeast was separated to obtain LUO HAN GUO juice (d); (5) the LUO HAN GUO juice (d) was treated with activated carbon, wherein the usage amount of the activated carbon was 1.0 kg, the particle size of the activated carbon was 120 mesh, the activated carbon was loaded on a chromatography column with a diameter of 8 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 60,000 Daltons, and the filtrate portion was then concentrated to 50 Brix by a nanofiltration membrane with a molecular weight cut-off of 100 Daltons to obtain LUO HAN GUO juice (f);

(7) citric acid was added to adjust the pH of LUO HAN GUO juice (f) to 5.5 to obtain LUO HAN GUO juice (g); and

(8) the LUO HAN GUO juice (g) was taken, and sterilization was performed under an ultra-high pressure of 530 MPa by maintaining the pressure for 25 min to obtain LUO HAN GUO juice (h).

The above steps were all performed in an environment at a temperature of 15° C.

### Example 5

(1) 500 kg of LUO HAN GUO fresh fruits were taken, washed and crushed, 0.25 kg of a macerating enzyme was added, and enzymolysis was performed under an ultra-high pressure of 140 MPa by maintaining the pressure for 14 min to obtain LUO HAN GUO juice (a);

(2) the LUO HAN GUO juice (a) was taken, and enzyme inactivation was performed under an ultra-high pressure of 400 MPa by maintaining the pressure for 9 min to obtain LUO HAN GUO juice (b);

(3) the LUO HAN GUO juice (b) was treated by a high-speed centrifuge with a rotation speed of 3000 r/min and centrifugation time of 7 min to obtain LUO HAN GUO juice (c);

(4) the LUO HAN GUO juice (c) was taken, 1.0 kg of a dry yeast was added for treatment for 480 min, and then the yeast was separated to obtain LUO HAN GUO juice (d);

(5) the LUO HAN GUO juice (d) was treated with activated carbon, wherein the usage amount of the activated carbon was 1.25 kg, the particle size of the activated carbon was 90 mesh, the activated carbon was loaded on a chromatography column with a diameter of 9 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 50,000 Daltons, and the filtrate portion was then concentrated to 65 Brix by a nanofiltration membrane with a molecular weight cut-off of 100 Daltons to obtain LUO HAN GUO juice (f);

(7) citric acid was added to adjust the pH of LUO HAN GUO juice (f) to 6.0 to obtain LUO HAN GUO juice (g); and

(8) the LUO HAN GUO juice (g) was taken, and sterilization was performed under an ultra-high pressure of 550 MPa by maintaining the pressure for 10 min to obtain LUO HAN GUO juice (h).

The above steps were all performed in an environment at a temperature of 25° C.

### Example 6

(1) 500 kg of LUO HAN GUO fresh fruits were taken, washed and crushed, 0.5 kg of a macerating enzyme was added, and enzymolysis was performed under an ultra-high pressure of 120 MPa by maintaining the pressure for 15 min to obtain LUO HAN GUO juice (a)

(2) the LUO HAN GUO juice (a) was taken, and enzyme inactivation was performed under an ultra-high pressure of 400 MPa by maintaining the pressure for 10 min to obtain LUO HAN GUO juice (b);

(3) the LUO HAN GUO juice (b) was treated by a high-speed centrifuge with a rotation speed of 4000 r/min and centrifugation time of 5 min to obtain LUO HAN GUO juice (c);

(4) the LUO HAN GUO juice (c) was taken, 1.0 kg of a fresh yeast was added for treatment for 360 min, and then the yeast was separated to obtain LUO HAN GUO juice (d);

(5) the LUO HAN GUO juice (d) was treated with activated carbon, wherein the usage amount of the activated carbon was 1.25 kg, the particle size of the activated carbon was 60 mesh, the activated carbon was loaded on a chromatography column with a diameter of 10 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 60,000 Daltons, and the filtrate portion was then concentrated to 50 Brix by a nanofiltration membrane with a molecular weight cut-off of 150 Daltons to obtain LUO HAN GUO juice (f);

(7) citric acid was added to adjust the pH of LUO HAN GUO juice (f) to 5.0 to obtain LUO HAN GUO juice (g); and

(8) the LUO HAN GUO juice (g) was taken, and sterilization was performed under an ultra-high pressure of 550 MPa by maintaining the pressure for 10 min to obtain LUO HAN GUO juice (h).

The above steps were all performed in an environment at a temperature of 30° C.

### Comparative Example 1

The present Comparative Example is used to evaluate the difference in technical effects between the technical solution of enzymolysis carried out at a temperature of 15° C. under normal pressure with sterilization by heating and the technical solution of the present invention. The specific steps were as follows:

(1) 400 kg of LUO HAN GUO fresh fruits were taken, washed and crushed, 0.2 kg of a macerating enzyme was added, and enzymolysis was performed for 12 min at a temperature of 15° C. under normal pressure to obtain LUO HAN GUO juice (a);

(2) the LUO HAN GUO juice (a) was taken, and enzyme inactivation was performed under an ultra-high pressure of 400 MPa by maintaining the pressure for 10 min to obtain LUO HAN GUO juice (b);

(3) the LUO HAN GUO juice (b) was treated by a filter press, and the LUO HAN GUO juice (b) was passed through a filter screen of 400 mesh with an operating pressure of 1 MPa to obtain LUO HAN GUO juice (c);

(4) the LUO HAN GUO juice (c) was taken, 0.6 kg of a dry yeast was added for treatment for 640 min, and then the yeast was separated to obtain LUO HAN GUO juice (d);

(5) the LUO HAN GUO juice (d) was treated with activated carbon, wherein the usage amount of the activated carbon was 1.0 kg, the particle size of the activated carbon was 120 mesh, the activated carbon was loaded on a chromatography column with a diameter of 7 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 60,000 Daltons, and the filtrate portion was then concentrated to 60 Brix by a nanofiltration membrane with a molecular weight cut-off of 150 Daltons to obtain LUO HAN GUO juice (f);

(7) citric acid was added to adjust the pH of LUO HAN GUO juice (f) to 5.0 to obtain LUO HAN GUO juice (g); and

(8) the LUO HAN GUO juice (g) was taken, and treated at a temperature of 120° C. for 10 s to obtain LUO HAN GUO juice (h).

### Comparative Example 2

The present Comparative Example is used to evaluate the difference in technical effects between the technical solution of enzymolysis carried out at a temperature of 45° C. under normal pressure with sterilization by heating and the technical solution of the present invention. The specific steps were as follows:

(1) 400 kg of LUO HAN GUO fresh fruits were taken, washed and crushed, 0.2 kg of a macerating enzyme was added, and enzymolysis was performed for 12 min at a temperature of 45° C. under normal pressure to obtain LUO HAN GUO juice (a);

(2) the LUO HAN GUO juice (a) was taken, and enzyme inactivation was performed under an ultra-high pressure of 400 MPa by maintaining the pressure for 10 min to obtain LUO HAN GUO juice (b);

(3) the LUO HAN GUO juice (b) was treated by a filter press, and the LUO HAN GUO juice (b) was passed through a filter screen of 400 mesh with an operating pressure of 1 MPa to obtain LUO HAN GUO juice (c);

(4) the LUO HAN GUO juice (c) was taken, 0.6 kg of a dry yeast was added for treatment for 60 min, and then the yeast was separated to obtain LUO HAN GUO juice (d);

(5) the LUO HAN GUO juice (d) was treated with activated carbon, wherein the usage amount of the activated carbon was 1.0 kg, the particle size of the activated carbon was 120 mesh, the activated carbon was loaded on a chromatography column with a diameter of 7 cm, and the LUO HAN GUO juice (d) was passed through the chromatography column to obtain LUO HAN GUO juice (e);

(6) the LUO HAN GUO juice (e) was passed through an ultrafiltration membrane with a molecular weight cut-off of 60,000 Daltons, and the filtrate portion was then concentrated to 60 Brix by a nanofiltration membrane with a molecular weight cut-off of 150 Daltons to obtain LUO HAN GUO juice (f);

(7) citric acid was added to adjust the pH of LUO HAN GUO juice (f) to 5.0 to obtain LUO HAN GUO juice (g); and

(8) the LUO HAN GUO juice (g) was taken, and treated at a temperature of 65° C. for 30 min to obtain LUO HAN GUO juice (h).

### Comparative Examples 3 to 8

Comparative Examples 3 to 8 are used to evaluate the difference in technical effects between the technical solutions of enzymolysis by maintaining other high-pressure conditions and the technical solution of the present invention. In Comparative Examples 3 to 8, enzymolysis was performed by maintaining the pressures of 40 MPa, 60 MPa, 80 MPa, 100 MPa, 240 MPa, and 260 MPa, respectively, and the other steps were the same as those of Example 3.

### Comparative Example 9

Comparative Example 9 is used to evaluate the difference in technical effects between the LUO HAN GUO juice prepared in reference document 1 and the technical solution of the present invention. The specific steps were as follows:

(1) 1 ton of LUO HAN GUO fresh fruits were taken and made into fruit pulp;

(2) citric acid was added to adjust pH to 5.5, the temperature was controlled at 50° C., and 4 kg of an immobilized fruit pulp enzyme was added;

(3) after enzymolysis for 30 minutes, the juice was filtered out with a plate and frame filter, 5 g of an ultrafiltration enzyme was added to the juice, and ultrafiltration was performed 60 minutes later;

(4) 1 kg of activated carbon was added to the obtained clarified juice, and centrifugation was performed after stirring for 5 minutes to separate the activated carbon; and

(5) vacuum concentration was performed till 50 Brix, then packaging was performed after instantaneous sterilization at an ultra-high temperature to obtain LUO HAN GUO juice (h).

### Comparative Example 10

Comparative Example 10 is used to evaluate the difference in technical effects between the LUO HAN GUO juice prepared in reference document 2 and the technical solution of the present invention. The specific steps were as follows:

(1) 400 kg of LUO HAN GUO fresh fruits were taken, washed with water, inactivated and crushed, 0.4 kg of pectinase was added, extraction was performed by maintaining a temperature of 37° C. for 2 h, first filtration was performed, 4000 L of deionized water was added to the filter residue, pectinase with the same weight as that of the first added pectinase was added, the same temperature was maintained for 1 h for extraction, filtration was performed again, the first and second filtrates were combined, then microfiltration was performed, and the micro-filtrate was collected and concentrated;

(2) the concentrated LUO HAN GUO juice was dissolved with 3 times amount of deionized water under stirring, introduced to SPC-1 type cation exchange resin at a flow rate of 0.3 times amount of the resin per hour, and eluted with water after sample instruction was finished, and the effluent was collected from the time when effluent with sweet taste appeared until sweetness of the effluent was very light;

(3) the effluent from step (2) was introduced to a D208 decolorizing resin at a flow rate of 0.5 times amount of resin per hour, and eluted with water after the sample introduction was finished, and the effluent was collected from the time when effluent with sweet taste appeared until sweetness of the effluent was very light;

(4) the pH of the decolorized juice was adjusted to 6.2; and

(5) under the conditions of a vacuum degree of 0.07 MPa, a temperature of 50° C. and a pressure of 0.04 MPa, the decolorized LUO HAN GUO juice was concentrated to 60 Brix to obtain LUO HAN GUO juice (h).

Physical and Chemical Indicators

1. Comparison of Juice Yield and Juicing Time

LUO HAN GUO juice (a) was prepared according to the methods of Examples 1 to 6 and Comparative Examples 1 to 2, and the juice yield was calculated (juice yield=(mass of LUO HAN GUO juice (a)/mass of LUO HAN GUO fresh fruits)×100%). The time taken to reach a juice yield of 20% was calculated. The comparison results were shown in Table 2.

TABLE 2
Comparison of juice yield and juicing time

| | Juice yield % | Juicing time (min) |
|---|---|---|
| Example 1 | 74.5 | 20 |
| Example 2 | 72.8 | 15 |
| Example 3 | 71.6 | 14 |
| Example 4 | 73.2 | 18 |
| Example 5 | 74.1 | 15 |
| Example 6 | 77.9 | 16 |
| Comparative | 59.7 | 42 |
| Example 1 | | |
| Comparative | 60.5 | 26 |
| Example 2 | | |

It can be seen from Table 2 that, compared with Comparative Examples 1 to 2 without ultra-high pressure treatment, Examples 1 to 6 of the present invention, in which a macerating enzyme is treated under ultra-high pressure, exhibit significantly higher juice yields, and the time taken to reach the juice yield of 20% is significantly shorter than that of Comparative Examples 1 to 2. It shows that the technical solution of the present invention adopting a macerating enzyme treated under ultra-high pressure has a better enzymolytic juicing effect than that of a macerating enzyme under ordinary conditions.

2. Comparison of Residual Enzyme Activity

The macerating enzyme was treated according to the temperature and pressure conditions in Examples 1 to 6 and Comparative Examples 1 to 8, respectively, and the enzyme activities before and after the pressure-maintaining enzymolysis were measured (parallel measurement for 5 times). The residual enzyme activity was calculated based on the enzyme activity (RA %, RA %=Aₜ/A_{O}×100%, Aₜ is the enzyme activity M/ml after high pressure treatment for a time period of t (min), and A_{O} is the enzyme activity Mimi at the pressure-maintaining time of 0 min). The comparison results were shown in Table 3.

TABLE 3
Comparison of residual enzyme activities

| | Residual enzyme activity % | | | | |
|---|---|---|---|---|---|
| | Pectinase | Cellulase | Protease | Amylase | Xylanase |
| Example 1 | 110.26 ± 0.48 | 125.72 ± 0.39 | 108.58 ± 0.16 | 110.52 ± 0.46 | 118.69 ± 0.24 |
| Example 2 | 112.71 ± 0.35 | 128.58 ± 0.41 | 115.62 ± 0.38 | 115.87 ± 0.72 | 125.18 ± 0.30 |
| Example 3 | 115.18 ± 0.51 | 131.47 ± 0.45 | 126.25 ± 0.25 | 121.95 ± 0.65 | 124.37 ± 0.25 |
| Example 4 | 108.34 ± 0.46 | 126.44 ± 0.32 | 109.37 ± 0.29 | 112.44 ± 0.52 | 118.75 ± 0.18 |
| Example 5 | 113.29 ± 0.41 | 129.65 ± 0.49 | 118.76 ± 0.42 | 118.92 ± 0.68 | 120.66 ± 0.56 |
| Example 6 | 117.52 ± 0.31 | 132.72 ± 0.45 | 125.47 ± 0.41 | 120.35 ± 0.49 | 122.72 ± 0.36 |
| Comparative | 101.25 ± 0.26 | 99.48 ± 0.36 | 101.52 ± 0.35 | 101.28 ± 0.58 | 99.14 ± 0.28 |
| Example 1 | | | | | |
| Comparative | 102.68 ± 0.45 | 101.28 ± 0.18 | 102.12 ± 0.39 | 103.58 ± 0.64 | 103.28 ± 0.42 |
| Example 2 | | | | | |
| Comparative | 89.52 ± 0.54 | 98.42 ± 0.45 | 95.44 ± 0.25 | 75.45 ± 0.38 | 84.82 ± 0.53 |
| Example 3 | | | | | |
| Comparative | 76.48 ± 0.49 | 86.72 ± 0.58 | 82.36 ± 0.42 | 76.92 ± 0.57 | 88.29 ± 0.68 |
| Example 4 | | | | | |
| Comparative | 75.26 ± 0.50 | 85.48 ± 0.54 | 81.95 ± 0.52 | 81.36 ± 0.42 | 89.22 ± 0.46 |
| Example 5 | | | | | |
| Comparative | 75.33 ± 0.64 | 84.26 ± 0.38 | 80.65 ± 0.46 | 82.43 ± 0.51 | 90.43 ± 0.21 |
| Example 6 | | | | | |
| Comparative | 95.62 ± 0.45 | 101.35 ± 0.28 | 99.72 ± 0.37 | 96.41 ± 0.46 | 98.25 ± 0.56 |
| Example 7 | | | | | |
| Comparative | 92.96 ± 0.32 | 95.63 ± 0.62 | 94.75 ± 0.58 | 90.86 ± 0.43 | 96.33 ± 0.54 |
| Example 8 | | | | | |

As shown in Table 3, it can be seen that, compared with Comparative Examples 1 to 8, the residual enzyme activities of each of the macerating enzymes of Examples 1 to 6 are significantly improved. The above results show that each component of the macerating enzyme treated under the ultra-high pressure of 120 to 220 MPa for 10 to 15 min exhibits significantly improved activation degree than that treated under low-temperature normal-pressure conditions and appropriate-temperature normal-pressure conditions, respectively. In addition, no matter the pressure is lower or higher than the pressure range defined by the present invention, the activity of each component of the macerating enzyme cannot be improved, and the activation of each component of the macerating enzyme is even continuously inhibited over time.

3. Comparison of Sterilization Effects

LUO HAN GUO juice (h) was prepared according to the methods of Examples 1 to 6 and Comparative Examples 1 to 2, and samples were taken to measure the contents of microorganisms (parallel measurement for 5 times). The comparison results were shown in Table 4.

TABLE 4
Comparison of sterilization effects

| | Total number | | | | | Staphylococcus |
|---|---|---|---|---|---|---|
| | of aerobic | Number of | Number of | | Salmonellae | aureus |
| | bacteria ≤100 | molds ≤10 | yeasts ≤10 | Coliforms ≤10 | (cf μ/25 ml) | (cf μ/25 ml) |
| | cf μ/ml | cf μ/ml | cf μ/ml | cf μ/ml | not detectable | not detectable |
| Example 1 | 80 | 5 | 4 | <1 | Fit | Fit |
| Example 2 | 70 | 6 | 3 | <1 | Fit | Fit |
| Example 3 | 75 | 5 | 3 | <1 | Fit | Fit |
| Example 4 | 70 | 4 | 2 | <1 | Fit | Fit |
| Example 5 | 81 | 5 | 5 | <1 | Fit | Fit |
| Example 6 | 70 | 7 | 5 | <1 | Fit | Fit |
| Comparative | 86 | 6 | 7 | <1 | Fit | Fit |
| Example 1 | | | | | | |
| Comparative | 90 | 8 | 4 | <1 | Fit | Fit |
| Example 2 | | | | | | |

It can be seen from Table 4 that, compared with Comparative Examples 1 to 2, there is no significant difference in each indicator such as the total number of bacteria in Examples 1 to 6 of the present invention, indicating that the sterilization effect achieved by the low-temperature ultra-high pressure sterilization adopted is equivalent to the effect of heat sterilization and meets the food requirements.

4. Comparison of Components

LUO HAN GUO juice (h) was prepared according to the methods of Examples 1 to 6 and Comparative Examples 1 to 2 and 9 to 10, and samples were taken to measure vitamin C, amino acid, and mogroside (parallel measurement for 5 times). The comparison results were shown in Table 5.

TABLE 5
Comparison of components

| | | | | Absorbance |
|---|---|---|---|---|
| | Vitamin | Total amino | | (460 nm, |
| | C (mg/g) | acids (mg/g) | Mogroside % | 0.1% w/v) |
| Example 1 | 0.45 ± 0.18 | 2.46 ± 0.37 | 0.51 ± 0.11 | 0.025 |
| Example 2 | 3.08 ± 0.55 | 11.23 ± 1.75 | 1.33 ± 0.18 | 0.031 |
| Example 3 | 2.79 ± 0.21 | 15.61 ± 0.97 | 2.72 ± 0.23 | 0.107 |
| Example 4 | 6.25 ± 1.25 | 21.25 ± 2.37 | 6.80 ± 0.29 | 0.118 |
| Example 5 | 6.27 ± 1.16 | 20.58 ± 2.28 | 8.91 ± 1.76 | 0.129 |
| Example 6 | 4.93 ± 1.37 | 16.33 ± 1.29 | 5.53 ± 0.21 | 0.115 |
| Comparative | 2.01 ± 0.35 | 12.14 ± 1.87 | 2.52 ± 0.10 | 0.135 |
| Example 1 | | | | |
| Comparative | 4.12 ± 1.75 | 11.52 ± 1.92 | 2.47 ± 0.11 | 0.353 |
| Example 2 | | | | |
| Comparative | 1.24 ± 0.24 | 8.21 ± 1.25 | 2.29 ± 0.09 | 0.330 |
| Example 9 | | | | |
| Comparative | 0.76 ± 0.18 | 1.90 ± 0.65 | 2.50 ± 0.11 | 0.175 |
| Example 10 | | | | |

It can be seen from Table 5 that, compared with Comparative Examples 1, 2, 9, and 10, the components such as vitamin C and amino acids of the LUO HAN GUO juice obtained in Examples 1 to 6 of the present invention are significantly increased. It shows that the present invention activates of the macerating enzyme by adopting ultra-high pressure treatment, thereby improving the enzymolytic effect, and significantly increasing the dissolution contents of target components such as vitamin C, amino acids and mogroside; and the present invention avoids the destruction of vitamin C and amino acids caused by heat sterilization by using low-temperature ultra-high pressure sterilization subsequently.

5. Comparison of the Sugar Contents of the Juice

LUO HAN GUO juice (h) was prepared according to Examples 1 to 6, and Comparative Examples 9 to 10, and samples were taken to measure the sugar contents of the juice. The comparison results were shown in Table 6.

TABLE 6
Comparison of the sugar contents of the juice

| | Sugar contents of the juice | | |
|---|---|---|---|
| | Sucrose g/100 g | Fructose g/100 g | Glucose g/100 g |
| Example 1 | 1< | 2< | 2< |
| Example 2 | 3< | 4< | 3< |
| Example 3 | 5< | 9< | 7< |
| Example 4 | 3< | 8< | 6< |
| Example 5 | 1< | 2< | 2< |
| Example 6 | 1< | 3< | 3< |
| Comparative | 8-15 | 11-13 | 9-12 |
| Example 9 | | | |
| Comparative | 9-14 | 12-14 | 10-13 |
| Example 10 | | | |

It can be seen from Table 6 that, compared with Comparative Examples 9 and 10, the LUO HAN GUO juice obtained in Examples 1 to 6 of the present invention exhibit significantly reduced contents of sucrose, fructose and glucose. It shows that the sugar contents and calories in the juice of the present invention can be reduced by treating the juice with a yeast.

6. Comparison of the Mouthfeel of the Products

The LUO HAN GUO juices (a) to (h) obtained in Example 1 were taken, and the mouthfeel were measured, respectively.

Each subject was sequentially given the LUO HAN GUO juices (a) to (h) obtained in Example 1 as the test products to be eaten with a total amount of 10 ml, which was eaten in two or three servings within 10 minutes. After each test product was eaten, it was necessary to wait for 15 min before continue to eat the next test product. Before starting of the experiment and during the waiting period, purified water and inorganic salt biscuits were used to clean up the taste of the subjects. The mouthfeel of each test product were evaluated in terms of characteristic smell, characteristic taste, sweetness, bitterness, astringency, and characteristic aftertaste. For each indicator, 0 is the minimum perception value, and 6 is the maximum perception value; and the results were expressed in average scores.

TABLE 7
Comparison of the mouthfeel of the products

| | LUO HAN GUO juices | | | | | | | |
|---|---|---|---|---|---|---|---|---|
| | a | b | c | d | e | f | g | h |
| Characteristic | 4.8 | 4.5 | 4.6 | 2.5 | 1.4 | 1.0 | 1.2 | 1.2 |
| smell | | | | | | | | |
| Characteristic | 4.2 | 4.4 | 4.3 | 2.6 | 1.8 | 1.5 | 1.4 | 1.4 |
| taste | | | | | | | | |
| Sweetness | 5.7 | 5.6 | 5.7 | 4.5 | 4.4 | 4.3 | 4.3 | 4.2 |
| Bitterness | 2.5 | 2.4 | 2.6 | 1.5 | 1.2 | 1.5 | 1.6 | 1.5 |
| Astringency | 2.4 | 2.2 | 2.2 | 1.4 | 1.2 | 1.1 | 1.0 | 1.0 |
| Characteristic | 4.5 | 4.6 | 4.5 | 3.2 | 2.4 | 1.3 | 1.5 | 1.4 |
| aftertaste | | | | | | | | |

As shown in Table 7, LUO HAN GUO juices (a) to (c) exhibit no significant difference in flavor to each other, and have obvious sweetness, but still prominent characteristic smell, characteristic taste, characteristic aftertaste, bitterness and astringency, which affect the overall mouthfeel. The LUO HAN GUO juice (d) undergoing yeast treatment provides lowered scores in each item except sweetness, that is, little effect is caused on sweetness, and obvious sweetness can still be felt. The above results show that the treatment of LUO HAN GUO juice with yeast has little effect on pleasant mouthfeel such as sweetness, but can obviously eliminate the disgusting mouthfeel such as characteristic smell, characteristic taste, characteristic aftertaste, bitterness and astringency.

### CONCLUSIONS

The technical solution of the present invention is superior to the prior art such as reference document 1 and reference document 2 in terms of improving the juice yield of LUO HAN GUO, shortening the juicing time, preserving the nutritional components of LUO HAN GUO juice, and improving the overall mouthfeel of LUO HAN GUO juice.

Although the general description, specific embodiments and experiments have been used to describe the present invention in detail above, some modifications or improvements can be made on the basis of the present invention, which is obvious to a person skilled in the art. Therefore, these modifications or improvements made without departing from the spirit of the present invention fall within the scope of protection of the present invention.

What is claimed is:

1. A preparation method of LUO HAN GUO juice, wherein the method comprises the following steps: taking fresh LUO HAN GUO fruits, adding a macerating enzyme, and performing enzymolysis while maintaining an ultra-high pressure of 120 to 220 MPa for 10 to 15 min to obtain enzymolyzed LUO HAN GUO juice.

2. The method according to claim 1, wherein the method comprises the following steps: taking fresh LUO HAN GUO fruits, adding a macerating enzyme, and performing enzymolysis while maintaining an ultra-high pressure of 140 to 180 MPa for 12 to 14 min to obtain enzymolyzed LUO HAN GUO juice.

3. The method according to claim 1, wherein the enzymolysis is performed under an ultra-high pressure condition at a temperature of ≤30° C.

4. The method according to claim 1, wherein the usage amount of the macerating enzyme is 0.5‰ to 1‰ of the weight of fresh fruits, and the composition ratio of the macerating enzyme is as follows: pectinase 3500 to 5000μ/g, cellulase 100 to 200μ/g, amylase 2000 to 3000μ/g, protease 4000 to 8000μ/g, and xylanase 3500 to 5000μ/g.

5. The method according to claim 1, wherein the method comprises the following steps: taking the enzymolyzed LUO HAN GUO juice, and inactivating enzyme while maintaining an ultra-high pressure of ≥400 MPa for 5 to 10 min to obtain enzyme-inactivated LUO HAN GUO juice.

6. The method according to claim 5, wherein the method comprises the following steps: taking the enzyme-inactivated LUO HAN GUO juice, and processing by a filter press or a high-speed centrifuge to obtain clarified LUO HAN GUO juice.

7. The method according to claim 6, wherein when a filter press is used for processing, the LUO HAN GUO juice obtained after enzyme inactivation is passed through a filter screen of 200 to 400 mesh with an operating pressure of ≥0.2 MPa.

8. The method according to claim 6, wherein when a high-speed centrifuge is used for processing, the rotation speed is 2000 to 4000 r/min, and the centrifugation time is 5 to 10 min.

9. The method according to claim 6, wherein the method comprises the following steps: taking the clarified LUO HAN GUO juice, adding a yeast and treating for 30 to 480 min, and then separating the yeast to obtain LUO HAN GUO juice treated with yeast.

10. The method according to claim 9, wherein the usage amount of the yeast is 1.5‰ to 2.0‰ of the weight of the fresh fruits, and the yeast is dry yeast or fresh yeast.

11. The method according to claim 9, wherein the method comprises the following steps: taking the LUO HAN GUO juice treated with yeast, and treating with activated carbon to obtain LUO HAN GUO juice treated with activated carbon.

12. The method according to claim 11, wherein the activated carbon is used in an amount of 2.5‰ of the weight of the fresh fruits, provided with a particle size of 60 to 120 mesh, and loaded on a chromatography column with a diameter of ≥5 cm to allow the LUO HAN GUO juice treated with yeast to pass through the chromatography column.

13. The method according to claim 11, wherein the method comprises the following steps: allowing the LUO HAN GUO juice treated with activated carbon to pass through an ultrafiltration membrane, concentrating the filtrate portion by a nanofiltration membrane to obtain concentrated LUO HAN GUO juice, adjusting the pH of the concentrated LUO HAN GUO juice to 4.0 to 6.5 to obtain LUO HAN GUO juice with weakly acidic pH.

14. The method according to claim 13, wherein the molecular weight cut-off of the ultrafiltration membrane is 50,000 to 60,000 Daltons, the molecular weight cut-off of the nanofiltration membrane is 100 to 150 Daltons, and the Brix of the concentrated LUO HAN GUO juice is 5° to 65°.

15. The method according to claim 13, wherein the method comprises the following steps: taking the LUO HAN GUO juice with weakly acidic pH, and sterilizing under an ultra-high pressure of 500 to 550 MPa at a temperature of ≤30° C. and maintaining the pressure for 20 to 30 min to obtain sterilized LUO HAN GUO juice.

16. A LUO HAN GUO juice, wherein the LUO HAN GUO juice is prepared by the method of any one of claims 1 to 15.
